(19) United States
(12) Patent Application Publication
(10) Pub. No.: US 2011/0092634 A1
(43) Pub. Date: Apr. 21, 2011

(54) POLYMERIC MICROGEL COMPRISING CATIONIC UNITS

(75) Inventors: Inigo Gonzalez, Paris (FR); David James Wilson, Paris (FR); Mathias Destarac, Paris (FR); Katerina Karagianni, Paris (FR)

(73) Assignee: Rhodia Operations, Aubervilliers (FR)

(21) Appl. No.: 12/664,312

(22) PCT Filed: Jun. 12, 2008
(86) PCT No.: PCT/EP08/57365

§ 371 Date: Jan. 6, 2011

(30) Foreign Application Priority Data
Jun. 14, 2007 (FR) 0704240

(51) Int. Cl. C08F 220/56; C08F 220/10; C08F 226/06; C08F 226/02; C08F 222/18; C08F 228/02; C08F 220/26; C08L 101/00

(52) U.S. Cl. 524/543; 526/72; 526/307; 526/303.1; 526/312; 526/263; 526/310; 526/292.2; 526/292.95; 526/287; 526/320; 526/264

(57) ABSTRACT

The present invention relates to novel polymeric microgels and to a method suitable for the preparation thereof. The novel microgels comprise cationic units.

The present invention has, as subject matter, novel polymeric microgels and a process suitable for their preparation. The novel microgeis comprise cationic units.

Microgels having a simple architecture (microgels sometimes referred to as first-generation microgels) or a star architecture exhibiting macromolecular branches at the periphery (microgels sometimes referred to as second-generation microgels or star copolymer or star microgel) have been described. These microgeis comprise a crosslinked polymeric core comprising units deriving from monofunctional monomers and units deriving from polyfunctional monomers. In the case of the microgels having a star architecture, the microgels exhibit macromolecular branches at the periphery of the core. The document WO 2004014535 describes, for example, microgels having a core exhibiting neutral hydrophilic units deriving from acrylamide or neutral hydrophobic units deriving from butyl acrylate. The document WO 2006067325 describes, for example, microgels having a star architecture, the core of which exhibits neutral hydrophilic units deriving from acrylamide or potentially anionic units deriving from acrylic acid. The document WO 2005116097 describes a process for the preparation of microgels having a star architecture, the core of which exhibits neutral hydrophilic units deriving from acrylamide or potentially anionic units deriving from acrylic acid. The documents WO 2000002939 and WO 2001077198 describe processes for the preparation of microgels having a star architecture comprising macromolecular chains at the periphery of a core. The document WO 0056792 describes microgels comprising neutral hydrophilic units deriving from acrylamide. The document WO 9958588 describes a process for the preparation of microgels having a star architecture comprising macromolecular chains at the periphery of a core. The document WO 9831739 describes microgels comprising neutral hydrophobic units, such as tert-butylstyrene (TBS), The documents WO 2004048428 and WO 2004048429 describe the preparation of microgels from neutral monofunctional units.

There exists a constant need industrially for novel polymers which can contribute novel properties or novel functionalities to applications where they are used or which can adjust properties or functionalities of the applications where they are used.

The invention meets this need by providing a chemically crosslinked polymeric microgel exhibiting a core C comprising:
crosslinking units R deriving from a crosslinking monomer R comprising at least two polymerizable groups, and
core C units deriving from at least one monomer C comprising just one polymerizable group, comprising;
   cationic or potentially cationic units C_{cat} deriving from at least one cationic or potentially cationic monomer C_{cat}, and
   optionally neutral hydrophilic or hydrophobic units C_{N} deriving from at least one neutral hydrophilic or hydrophobic monomer C_{N},
      the microgel being other than a star copolymer comprising macromolecular branches at the periphery of the core.

The invention also relates to a process for the preparation of the microgels. The invention also relates to uses of the microgels. The invention also relates to compositions, preferably aqueous (comprising water) compositions, comprising the microgels.

### Definitions

In the present patent application, microgel is understood to mean a macromolecular compound which is a copolymer and which exhibits a core. The term microgel also denotes a nanogel if the sizes render this name more appropriate. A core is a chemically crosslinked macromolecule comprising units deriving from a monomer comprising just one polymerizable functional group and units comprising at least two polymerizable functional groups. The microgel of the invention is different from a microgel comprising, at the periphery of the core, macromolecular branches bonded to the core. The term core is used as opposed to macromolecular branches at the periphery. Microgels exhibiting a core and not branches at the periphery are macromolecular architectures known to a person skilled in the art. The term “star copolymer” is also sometimes used to denote microgels comprising macromolecular branches at the periphery of the core.

In the present patent application, “core C” records a microgel comprising a chemically crosslinked polymeric core but not comprising macromolecular branches at the periphery of the core. Microscopic macromolecules with intrachain crosslinkings are involved. Such cores C can be obtained by copolymerization of a monomer C exhibiting just one polymerizable group and of a crosslinking monomer R exhibiting at least two polymerizable groups (crosslinking monomer) in the absence of surfactant or in the presence of a small amount of surfactant (for example less than 10% by weight, preferably less than 5% by weight, indeed even less than 1% by weight or not at all). They are distinguished in particular in this from “nanolatexes”, polymers obtained by emulsion polymerization in the presence of large amounts of surfactants at or close to thermodynamic equilibrium.

In the present patent application, unit deriving from a monomer denotes a unit which can be obtained directly from said monomer by polymerization. Thus, for example, a unit deriving from an acrylic or methacrylic acid ester does not cover a unit of formula —CH₂—CH(COOH)—, —CH₂—C(CH₃)(COOH)— or —CH₂—CH(OH)— respectively obtained, for example, by polymerizing an acrylic acid ester, a methacrylic acid ester or vinyl acetate respectively and by then hydrolyzing. A unit deriving from acrylic or methacrylic acid covers, for example, a unit obtained by polymerizing a monomer (for example, an acrylic or methacrylic acid ester) and by then reacting (for example by hydrolysis) the polymer obtained so as to obtain units of formula —CH₂—CH(COOH)— or —CH₂—C(CH₃)(COOH)—. A unit deriving from a vinyl alcohol covers, for example, a unit obtained by polymerizing a monomer (for example, a vinyl ester), and by then reacting (for example by hydrolysis) the polymer obtained so as to obtain units of formula —CH₂—CH(OH)—.

The following symbols are defined:
N_{R} is the number of polymerizable functional groups (typically of ethylenically unsaturated functional groups) in a crosslinking monomer R,
n_{R} is the number of moles of crosslinking monomer(s) R,
n_{T} is the total number of moles of monomers (monomer(s) C monomer(s) R),
N_{Control} is the number of control groups in a control agent, if such an agent is used during the polymerization,
n_{Control} is the number of moles of control agent, if such an agent is used during the polymerization,
r=(N_{Control}*n_{Control}/n_{T})/(N_{R}/2)*(n_{R}/n_{T})=2*(N_{Control}*n_{Control})/(N_{R}*n_{R}).

In the present patent application, the term “hydrophobic”, for a monomer, is used in its usual sense of “which does not have an affinity for water”; this means that the monomer can form a two-phase macroscopic solution in distilled water at 25° C., at a concentration of greater than or equal to 1% by weight, or that it has been categorized as hydrophobic in the present patent application.

In the present patent application, the term “hydrophilic”, for a monomer, is also used in its usual sense of “which has an affinity for water”, that is to say is not capable of forming a two-phase macroscopic solution in distilled water at 25° C. at a concentration of greater than or equal to 1% by weight, or that it has been categorized as hydrophilic in the present patent application.

Cationic or potentially cationic units is understood to mean units which comprise a cationic or potentially cationic group. Cationic units or groups are units or groups which exhibit at least one positive charge (generally in combination with one or more anions, such as the chloride ion, the bromide ion, a sulfate group or a methyl sulfate group), whatever the pH of the medium into which the microgel is introduced, Potentially cationic units or groups are units or groups which may be neutral or which may exhibit at least one positive charge, depending on the pH of the medium into which the microgel is introduced. In this case, reference will be made to potentially cationic units in the neutral form or in the cationic form, By extension, it is possible to speak of cationic or potentially cationic monomers.

Anionic or potentially anionic units is understood to mean units which comprise an anionic or potentially anionic group. Anionic units or groups are units or groups which exhibit at least one negative charge (generally in combination with one or more cations, such as cations of alkali metal or alkaline earth metal compounds, for example sodium, or with one or more cationic compounds, such as ammonium), whatever the pH of the medium in which the microgel is present. Potentially anionic units or groups are units or groups which may be neutral or which may exhibit at least one negative charge, depending on the pH of the medium in which the microgel is present. In this case, reference will be made to potentially anionic units in the neutral form or in the anionic form. By extension, it is possible to speak of anionic or potentially anionic monomers.

Neutral units is understood to mean units which do not exhibit a charge, whatever the pH of the medium in which the microgel is present.

### Microgels of the Invention

The microgel of the invention (core C) comprises:
crosslinking units R deriving from a crosslinking monomer R comprising at least two polymerizable groups, and
core C units deriving from at least one monomer C comprising just one polymerizable group, comprising
   cationic or potentially cationic units C_{cat} deriving from at least one cationic or potentially cationic monomer C_{cat}, and
   optionally neutral hydrophilic or hydrophobic units C_{N} deriving from at least one neutral hydrophilic or hydrophobic monomer C_{N}.

The polymerizable groups of the monomers C and R are preferably ethylenically unsaturated groups, preferably α-ethylenically unsaturated groups. The monomers C are thus preferably monoethylenically unsaturated monomers, preferably mono-α-ethylenically unsaturated monomers. The monomers R are thus preferably polyethylenically unsaturated monomers, preferably di- or triethylenicaily unsaturated monomers, for example di-α-ethylenically unsaturated or tri-α-ethylenically unsaturated monomers.

It is not ruled out for the units C and the monomers C to comprise several different units or to derive from several different monomers. It is not ruled out for the units C_{cat} and the monomers C_{cat} to comprise several different units or to derive from several different monomers. It is noted that the units C or the monomers C can simultaneously comprise units C_{cat} and units C_{N} or can derive both from monomers C_{cat} and C_{N}. The units C and the monomers C can in addition optionally comprise other types of units or can optionally derive from other monomers. The units C can in particular additionally comprise zwitterionic units C_{Z} deriving from zwitterionic monomers C_{Z} and/or anionic or potentially anionic units C_{A} deriving from anionic or potentially anionic monomers C_{A}.

The microgel is capable of being obtained by a process employing a controlled radical polymerization process, as set out below.

The microgel is different from a star copolymer comprising a core C and, at the periphery of the core, macromolecular branches. The microgel can exhibit a control group or a residue of such a group at ends of the polymer molecules.

The microgel can be presented in particular in the form of a powder, in the form of a dispersion in a liquid or in the form of a solution in a solvent. The latter two forms can be put into the same category as forms in dispersed media. The microgel can, for example, be included in an aqueous (comprising water) medium, for example in an aqueous or other medium. The form generally depends on the requirements related to the use of the microgel. It can also be related to the process for the preparation of the microgel.

The microgel can in particular be composed of crosslinked macromolecules with a mean size ranging from 5 nm to 10 μm, for example from 5 nm to 100 nm (it is possible to speak of nanogels) or from 100 nm to 1 μm (for example, from 100 nm to 200 nm, or from 200 nm to 300 nm, or from 300 nm to 400 nm, or from 400 nm to 500 nm, or from 500 nm to 600 nm, or from 600 nm to 700 nm, or from 700 nm to 800 rim, or from 800 nm to 900 nm, or from 900 nm to 1 μm) or from 1 μm to 5 or 10 μm. The sizes can be determined conventionally by light scattering or X-ray diffraction technique in disperse media.

The microgel, and its process of preparation, is preferably such that it does not form a crosslinked macroscopic macromolecular network (interchain crosslinking). If it is in a disperse medium, for example in an aqueous medium, the microgel advantageously exhibits a viscosity (Brookfield) of less than 20 000 cP, preferably of less than 10 000 cP, at 25° C., at a shear rate of 100 s⁻¹ or less, or preferably at a shear rate of 10 s⁻¹.

It has in particular been noticed that microgels exhibiting cationic or potentially cationic units C_{cat} can exhibit particularly small sizes and the processes employing monomers C_{cat} can make it possible to substantially reduce the size of the microgels. The invention can make it possible in a simple way to reduce the sizes.

The microgel (core C) comprises polymerized units. All the units mentioned below can be envisaged, and their combinations. Some combinations are the subject of specific embodiments.

Mention may be made, as examples of potentially cationic monomers C_{cat} from which the potentially cationic units C_{cat} can be derived, of:
ω-(N,N-dialkylamino)alkylamides of α,β-mono-ethylenically unsaturated carboxylic acids, such as N,N-dimethylaminomethylacrylamide or -methacrylamide, 2-(N,N-dimethylamino)ethyl-acrylamide or -methacrylamide, 3-(N,N-dimethyl-amino)propylacrylamide or -methacrylamide, or 4-(N,N-dimethylaminc)butylaorylamide or -methacrylamide,
α,β-monoethylenically unsaturated amino esters, such as 2-(dimethylamino)ethyl acrylate (ADAM), 2-(dimethylamino)ethyl methacrylate (DMAM or MADAM), 3-(dimethylamino)propyl methacrylate, 2-(tert-butylamino)ethyl methacrylate, 2-(dipentyl-amino)ethyl methacrylate or 2-(diethylamino)ethyl methacrylate,
vinylpyridines,
vinylamine,
vinylimidazolines,
precursor monomers of amine functional groups, such as N-vinylformamide, N-vinylacetamide, and the like, which produce primary amine functional groups by simple acidic or basic hydrolysis,
their mixtures or combinations.

Mention may be made, as examples of cationic monomers C_{cat} from which the cationic units C_{cat} can be derived, of:
ammonioacryloyl or -acryloyloxy monomers, such as
   trimethylammoniopropyl methacrylate salts, in particular the chloride,
   trimethylammonioethylacrylamide or -methacryl-amide chloride or bromide,
   trimethylammoniobutylacrylamide or methacrylamide methyl sulfate,
   trimethylammoniopropylmethacrylamide methyl sulfate (MAPTA MeS),
   (3-methacrylamidopropyl) trimethylammonium chloride (MAPTAC),
   (3-acrylamidopropyl) trimethylammonium chloride or methyl sulfate (APTAC or APTA MeS),
   (methacryloyloxyethyl)trimethylammonium chloride or methyl sulfate,
   (acryloyloxyethyl)trimethylammonium (ADAMQUAT) salts, such as (acryloyloxyethyl)trimethylammonium chloride or (acryloyloxyethyl)trimethylammonium methyl sulfate (ADAMQUAT Cl or ADAMQUAT MeS),
methyldiethylammonioethyl acrylate methyl sulfate (ADAEQUAT MeS)
benzyldimethylammonioethyl acrylate chloride or methyl sulfate (ADAMQUAT BZ 80),
1-ethyl-2-vinylpyridinium or 1-ethyl-4-vinyl-pyridinium bromide, chloride or methyl sulfate,
N,N-dialkyldiallylamine monomers, such as N,N-dimethyldiallylammonium chloride (aADMAC),
the chloride of dimethylaminopropylmethacrylamide, N-(3-chloro-2-hydroxypropyl)trimethylammcnium (DIQUAT chloride),
the methyl sulfate of dimethylaminopropyl-methacrylamide, N-(3-methylsulfate-2-hydroxypropyl)-trimethylammonium (DIQUAT methylsulfate),
the monomer of formula

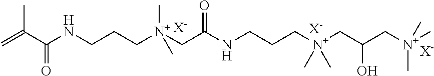

where X⁻ is an anion, preferably chloride or methyl sulfate, their mixtures or combine ions.

Mention may be made, as examples of neutral hydrophilic monomers C_{Nphilic} from which the neutral hydrophilic units C_{Nphilic} can be derived, of:
hydroxyalkyl esters of α,β-ethylenically unsaturated acids, such as hydroxyethyl acrylate, hydroxyethyl methacrylate, hydroxypropyl acrylate, hydroxypropyl methacrylate, glycerol monometh-acrylate, and the like,
α,β-ethylenically unsaturated amides, such as acrylamide, methacrylamide, N,N-dimethylmethacrylamide, N-methylolacrylamide, and the like,
α,β-ethylenically unsaturated monomers carrying a water-soluble polyoxyalkylene segment of the polyethylene oxide type, such as polyethylene oxide α-methacrylates (Bisomer S20W, S10W, and the like, from Laporte) or α,ω-dimethacrylates, Sipomer BEM from Rhodia (ω-behenyl polyoxyethylene methacrylate), Sipomer SEM-25 from Rhodia (ω-tristyrylphenyl polyoxyethylene methacrylate), and the like,
vinyl alcohol,
α,β-ethylenically unsaturated precursor monomers of hydrophilic units or segments, such as vinyl acetate, which, once polymerized, can be hydrolyzed to generate vinyl alcohol units or polyvinyl alcohol segments,
vinyllactams, such as vinylpyrrolidones or N-vinylcaprolactam,
α,β-ethylenically unsaturated monomers of ureido type and in particular methacrylamidoethyl-2-imidazolidinone (Sipomer WAM II from Rhodia),
nonethylene glycol methyl ether acrylate or nonethylene glycol methyl ether methacrylate,
their mixtures or combinations.

Mention may be made, as examples of neutral hydrophobic monomers C_{Nphobic} from which neutral hydrophobic units C_{Nphobic} can be derived, of:
vinylaromatic monomers, such as styrene, α-methylstyrene, vinyltoluene, and the like,
vinyl or vinylidene halides, such as vinyl chloride or vinylidene chloride,
C₁-C₁₂ alkyl esters of α,β-monoethylenically unsaturated acids, such as methyl acrylate, methyl methacrylate, ethyl acrylate, ethyl methacrylate, butyl acrylate, butyl methacrylate, 2-ethylhexyl acrylate, and the like,
vinyl or allyl esters of saturated carboxylic acids, such as vinyl acetate, allyl acetate, vinyl propionate, allyl propionate, vinyl versatate, allyl versatate, vinyl stearate, allyl stearate, and the like,
α,β-monoethylenically unsaturated nitriles comprising from 3 to 12 carbon atoms, such as acrylonitrile, methacrylonitrile, and the like,
α-olefins, such as ethylene, and the like,
conjugated dienes, such as butadiene, isoprene or chloroprene,
monomers capable of enerating polydimethylsiloxane (PDMS) chains.
Thus, the part B can be a silicone, for example a polydimethylsiloxane chain or a copolymer comprising dimethylsiloxy units,
diethylene glycol ethyl ether acrylate or diethylene glycol ethyl ether methacrylate,
their mixtures or combinations.

Mention may be made, as examples of anionic or otentiall anionic monomers C_{A} from which anionic or potentially anionic units C_{A} can be derived, of
monomers having at least one carboxyl functional group, such as α,β-ethylenically unsaturated (SHPP), sulfopropyldiethylammonioethyl methacrylate or (sulfohydroxypropyl)diethylammonioethyl methacrylate,
monomers carrying a phosphobetaine group, such as phosphatoethyltrimethylammonioethyl methacrylate,
their mixtures or combinations.

The crosslinking monomers R from which crosslinking units R can be derived can in particular be chosen from organic compounds which comprise at least two ethylenic unsaturations and at most 10 unsaturations and which are known to be reactive by the radical route. Preferably, these monomers exhibit two or three ethylenic unsaturations.

Thus, mention may in particular be made of acrylic, methacrylic, acrylamido, methacrylamido, vinyl ester, vinyl ether, diene, styrene, α-methylstyrene and allyl derivatives, These monomers can also include functional groups other than ethylenic unsaturations, for example hydroxyl, carboxyl, ester, amide, amino or substituted amino, mercapto, silyl, epoxy or halo functional groups.

The monomers belonging to these families are divinylbenzene and divinylbenzene derivatives, vinyl methacrylate, methacrylic acid anhydride, allyl methacrylate, ethylene glycol dimethacrylate, phenylene dimethacrylate, diethylene glycol dimethacrylate, triethylene glycol dimethacrylate, tetraethylene glycol dimethacrylate, polyethylene glycol 200 dimethacrylate, polyethylene glycol 400 dimethacrylate, 1,3-butanediol dimethacrylate, 1,4-butanediol dimethacrylate, 1,6-hexanediol dimethacrylate, 1,12-dodeoanediol dimethacrylate, 1,3-glycerol dimethacrylate, diurethane dimethacrylate or trimethylolpropane trimethacrylate. For the family of the polyfunctional acrylates, mention may in particular be made of vinyl acrylate, bisphenol A epoxy diacrylate, dipropylene glycol diacrylate, tripropylene glycol diacrylate, polyethylene glycol 600 diacrylate, ethylene glycol diacrylate, diethylene glycol diacrylate, triethylene glycol diacrylate, tetraethylene glycol diacrylate, neopentyl glycol ethoxylate diacrylate, butanediol diacrylate, hexanediol diacrylate, aliphatic urethane diacrylate, trimethylolpropane triacrylate, trimethylolpropane ethoxylate triacrylate, trimethylolpropane propoxylate triacrylate, glycerol propoxylate triacrylate, aliphatic urethane triacrylate, trimethylolpropane tetraacrylate or dipentaerythritol pentaacrylate. As regards the vinyl ethers, mention may in particular be made of vinyl crotonate, diethylene glycol divinyl ether, 1,4-butanediol divinyl ether or triethylene glycol divinyl ether. For the allyl derivatives, mention may in particular be made of diallyl phthalate, diallyldimethylammonium chloride, diallyl maleate, sodium diallyloxyacetate, diallylphenylphospthine, diallyl pyrocarbonate, diallyl succinate, N,N′-diallyl-tartardiamide, N,N-diallyl-2,2,2-trifluoroacetamide, the allyl ester of diallyloxyacetic acid, 1,3-diallylurea, triallylamine, triallyl trimesate, triallyl cyanurate, triallyl trimellitate or 1,3,5-triallyltriazine-2,4,5(1H,3H,5W-trione. For the acrylamido derivatives, mention may in particular be made of N,Ni-methylenebisacrylamide, N,N′-methylenebismethacrylamide, glyoxalbisacrylamide or diacrylamidoacetic acid. As regards the styrene derivatives, mention may in particular be made of divinylbenzene and 1,3-diisopropenylbenzene. In the case of the diene monomers, mention may in particular be made of butadiene, chloroprene and isoprene.

Preference is given, as palyethylenically unsaturated monomers, to N,N′-methylenebisacrylamide (MBA), divinylbenzene (DVB), ethylene glycol diacrylate, triallyl cyanurate (TAC) or trimethylolpropane triacrylate.

These polyethylenically unsaturated monomers can be used alone or as mixtures.

If the microgel comprises units C_{N}, they can advantageously be units C_{Nphilic} deriving from a neutral hydrophilic monomer C_{Nphilic}. The molar ratio of the units C_{cat} to the units C_{N}, preferably C_{Nphilic}, can in particular be between 1/99 and 99/1, preferably between 1/99 and 50/50, preferably between 1/99 and 40/60, preferably between 1/99 and 25/75, for example between 2/99 and 10/90.

Microgels having the following compositions of units C can in particular be prepared:
APTAC/AM, for example with an APTAC/AM molar ratio of 1/99 to 40/60, preferably of 5/95 to 30/70,
DIQUAT/AM, for example with a DIQUAT/AM molar ratio of 1/99 to 10/90,
MAPTAC/AM, for example with a MAPTAC/AM molar ratio of 1/99 to 10/90.

### Processes of Use in the Preparation of the Microgel

All the processes which make it possible to prepare microgels such as described above can be used.

Particularly advantageous processes employ a controlled (or “living”) polymerization using a control agent or group (sometimes denoted transfer group), for example a controlled (or “living”) radical polymerization process. Such processes are known to a person skilled in the art. It is mentioned that it is not ruled out to use other methods, in particular ring opening (in particular anionic or cationic) polymerizations or anionic or cationic polymerizations.

Reference may in particular be made, as examples of “living” or “controlled” radical polymerization processes, to the following processes:
the processes of applications WO 98/58974, WO 00/75207 and WO 01/42312, which employ a radical polymerization controlled by control agents of xanthate type,
the radical polymerization process controlled by control agents of dithioester or trithiocarbonate type of application WO 98/01478,
the radical polymerization process controlled by control agents of dithiocarbamate type of application WO 99/31144,
the radical polymerization process controlled by control agents of dithiocarbazate type of application WO 02/26836,
the radical polymerization process controlled by control agents of dithiophosphoric ester type of application WO 02/10223,
   (optionally the copolymers obtained as above by controlled radical polymerization can be subjected to a reaction for the purification of their sulfur-comprising chain end, for example by processes of hydrolysis, oxidation, reduction, pyrolysis or substitution type)
the process for application WO 99/03894, which employs a polymerization in the presence of nitroxide precursors,
the process of application WO 96/30421, which uses an atom transfer radical polymerization (ATRP), the radical polymerization process controlled by control agents of iniferter type according to the teaching of Otu et al., Macromol. Chem. Rapid Commun., 3, 127 (1982),
the radical polymerization process controlled by iodine degenerative transfer according to the teaching of Tatemoto at al., Jap. 50, 127, 991 (1975), Daikin Kogyo Co, Ltd., Japan, and Matyjaszewski et al., Macromolecules, 28, 2093 (1995),
the radical polymerization process controlled by tetraphenylethane derivatives disclosed by D. Braun et al. in Macromol. Symp., 111, 63 (1996), or also
the radical polymerization process controlled by organocobalt complexes described by Wayland et al. in J. Am. Chem. Soc., 116, 7973 (1994),
the radical polymerization process controlled by diphenylethvlene (WO 00/39169 or WO 00/37507),

The controlled or living radical polymerizations employing control agents or groups (or “transfer agents or groups”) exhibiting an —S—CS— group (xanthates, dithioesters, trithiocarbonates, dithiocarbamates, dithiocarbazates, and the like) are particularly advantageous.

A practical process for the preparation of the microgel is a preparation process comprising the following stage a):

Stage a) polymerization, preferably controlled radical polymerization, of a mixture of monomers comprising:
at least one polyethylenically unsaturated crosslinking monomer R, and
at least one monoethylenically unsaturated monomer C, comprising:
   at least one cationic or potentially cationic monomer C_{cat}, and
   optionally a neutral hydrophilic or hydrophobic monomer C_{N},
      the process not comprising a subsequent stage of polymerization which may result in the formation of macromolecular branches at the periphery.

The molar ratio of the monomer(s) C to the monomer(s) R is preferably greater than or equal to 50/50 (=1), preferably greater than 60/40, for example from 60/40 to 99.99/0.01, for example from 60/40 to 99.9/0.1, preferably from 60/40 to 99/1, preferably from 80/20 to 95/5. The ratio of the units C to the units R can be identical.

The polymerization of stage a) can in particular be carried out by bringing together
the monomers,
a control agent, for example an agent comprising an —S—CS— group, and
a source of free radicals.

Such polymerization typologies are known to a person skilled in the art and have formed the subject of numerous publications. Reference is made in particular to the list drawn up above.

It is mentioned that stage a) can be followed by an optional stage b) of chemical modification of the macromolecular chains and/or of deactivation of transfer groups carried by macromolecular chains, of destruction of or purification from byproducts of the chemical modification and/or deactivation.

Stages of chemical modification of the macromolecular chains are targeted at adding functional groups to the chains, at removing groups from the macromolecular chains or at replacing groups of the macromolecular chains. These groups can in particular be carried by units deriving from monomers or carried as macromolecular chain ends. Such processes are known to a person skilled in the art. Mention is made, for example, of stages of complete or partial hydrolysis or stages of complete or partial crosslinking.

The deactivation of transfer groups carried by the macromolecular chains and/or purification from and/or destruction of byproducts from the chemical modification and/or deactivation can be carried out. It may involve a reaction for the purification from or destruction of certain entities, for example by processes of hydrolysis, oxidation, reduction, pyrrolysis, ozonolysis or replacement type. A stage of oxidation with aqueous hydrogen peroxide solution is particularly appropriate for treating sulfur-comprising entities. It is mentioned that some of these reactions or operations can take place in all or part during a stage of chemical modification.

The polymerization stage a) will generally be carried out in the presence of a control agent (or transfer agent) exhibiting a control group (or transfer group). The control group is preferably a group of formula —S—CS—. It is preferably a nonpolymeric transfer agent, comprising a control group of formula —S—CS—. Control groups of formula —S—CS— and compounds comprising these groups, in particular control agents, are known to a person skilled in the art and are described in the literature. Reference is in particular made to the list drawn up above. They can in particular be selected according to their reactivity with regard to certain monomers and/or according to their solubility in the reaction medium.

The control group can in particular comprise a group of formula

—S—CS—Z, where Z is an oxygen atom, a carbon atom, a sulfur atom, a phosphorus atom or a silicon atom, these atoms being, if appropriate, substituted so as to have an appropriate valency. Use may in particular be made of an agent of xanthate type, exhibiting a control group of formula —S—CS—O—.

Mention is made, as particularly useful control agents, of:
O-ethyl S-[1-(methoxycarbonyl)ethyl] xanthate of formula

(CH₃CH(CO₂CH₃))S(C═S)OEt
dibenzyl trithiocarbonate of formula

φ-CH₂—S—CS—S—CH₂-φ.
phenyl benzyl dithiocarbonate of formula

φ-S—CS—CH₂-φ
S-benzyl N,N-diethyldithiocarbamate of formula

(CH₃—CH₂)₂N—CS—S—CH₂-φ.

The polymerization stage a) will generally be carried out in the presence of a source of ree radicals. However, for some monomers, such as styrene, the free radicals which make it possible to initiate the polymerization can be generated by a monoethylenically unsaturated monomer at sufficiently high temperatures, generally greater than 100° C. In this case, it is not necessary to add a source of additional free radicals.

The source of free radicals which is of use is generally a radical polymerization initiator. The radical polymerization initiator can be chosen from the initiators conventionally used in radical polymerization, It can, for example, be one of the following initiators:
hydrogen peroxides, such as tert-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, potassium persulfate or ammonium persulfate,
azo compounds, such as: 2,2′-azobisisobutyronitrile, 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis{2-methyl-N-[1,1-bis(hydroxymethyl)-2-hydroxyethyl]propionamide}, 2,2′-azobis[2-methyl-N-(hydroxyethyl)propionamide], 2,2′-azobis(N,N′-dimethyleneisobutyramidine) dichloride, 2,2′-azobis(2-amidinopropane) dichloride, 2,2′-azobis(N,N′-dimethyleneisobutyramide), 2,2′-azobis{2-methyl-N-[1,1-bis(hydroxymethyl)-2-hydroxyethyl]-propionamide}, 2,2′-azobis(2-methyl-N-[1,1-bis(hydroxymethyl)ethyl]propionamide), 2,2′-azobis[2-methyl-N-(2-hydroxyethyl)propionamide] or 2,2′-azobis(isobutyramide) dihydrate,
redox systems comprising combinations, such as:
mixtures of hydrogen peroxide, alkyl peroxide, peresters, percarbonates and the like and of any iron salt, titanous salt, zinc formaldehydesulfoxylate or sodium formaldehydesulfoxylate, and reducing sugars,
alkali metal or ammonium persulfates, perborates or perehlorates, in combination with an alkali metal bisulfite, such as sodium metabisulfite, and reducing sugars, and
alkali metal persulfates in combination with an aryiphosphinic acid, such as benzenephosphonic acid and others of a like nature, and reducing sugars.

The amount of initiator to be used is preferably determined so that the amount of radicals generated is at most 50 mol %, preferably at most 20 mol %, with respect to the amount of control or transfer agent.

It is mentioned that the polymerization can be carried out by heating, in a known way, so as to initiate and/or maintain the polymerization process. It is possible, for example, to operate at temperatures from 50° C. to 100° C. The degree of polymerization and the weights can be controlled by controlling the polymerization time. The polymerization can in particular be halted by lowering the temperature.

The polymerizations can be carried out in any appropriate physical form, for example by polymerization in solution in an aqueous (comprising water) medium, for example in water or in an aqueous/alcoholic (for example aqueous/ethanolic) medium, or in a solvent, for example an alcohol (for example ethanol) or THF, or by emulsion polymerization, preferably inverse emulsion polymerization, if appropriate while controlling the temperature and/or the pH in order to render entities liquid and/or soluble or insoluble. The polymerization is preferably carried out in solution, in contrast to disperse-phase polymerizations (emulsion, microemulsion, polymerization with precipitation of the polymer formed). It is preferable to retain the microgel in solution after such a polymerization.

It is specified that the microgels are preferably obtained directly after the polymerization and the optional deactivation, removal or destruction of transfer groups, without a stage of functionalization after the polymerization.

The respective and relative amounts of monomer(s) C, crosslinking monomer(s) R and control agent can be varied so as to control the size of the macromolecules generated and/or so as to control the nonformation of a macroscopic macromolecular network. Some indications are given below:
at constant amounts of monomer(s) C and control agent, when the amount of monomer(s) R is increased, the molecular weights and the polydispersity index are increased and macroscopic macromolecular networks may be formed,
at constant amounts of monomer(s) C and monomer(s) R, when the amount of control agent is reduced, the molecular weights and the polydispersity index are increased and macroscopic macromolecular networks may be formed,
at constant amounts of control agent and monomer(s) R, if units C_{N} are present, when the C_{cat}/C_{N} molar ratio is reduced, macroscopic macromolecular networks may be formed.

Preferably, the polymerization is carried out in the presence of a control agent in an amount such that (N_{Control}*n_{Control}/n_{T}) is from 0.05 to 10%, preferably from 0.1 to 10%, preferably from 0.2 to 5%.

Preferably, the polymerization is carried out in the presence of crosslinking monomers R in an amount such that (N_{R}/2)*(n_{R}/n_{T}) is from 0.01 to 40 mol %, preferably from 0.1 to 40 mol %, preferably from 1 to 40 mol %, for example from 5 to 20%.

The polymerization is preferably, in particular within one or both ranges mentioned above, carried out in the presence of a control agent and crosslinking monomer(s) R in amounts such that r≧0.05, preferably r≧0.1, preferably r≧0.2, preferably r≧0.25, preferably r≧0.3. The higher r, the greater the distance from a potential region of formation of undesirable macroscopic macromolecular networks. It has been found that the presence of the monomers C_{cat} can make it possible to operate in regions where r is relatively low, lower than in the absence of such a monomer, which widens the field of operability in particular the field in which macroscopic macromolecular networks are not formed) and widens the product range which it is possible to prepare, in particular in terms of size and/or density of the molecules of microgels. It is not ruled out for the number r to be greater than or equal to 0.5 or 1.

In particular, it has been found that the use of monomers C_{cat} can widen or shift the fields of relative proportions between the monomer(s) C, the monomer(s) R and the control agent in which macromolecules of controlled size, for example smaller macromolecules, are formed and/or in which macroscopic macromolecular networks (excessively viscous) are not formed.

### Uses

The microgels of the invention can in particular be used for the treatment and/or modification of surfaces. They can in particular be used in the field of coatings (for example in the field of paints), either as additive in the coating or as pretreatment, for example intended to improve the adhesion of a subsequent coating. The microgels of the invention can in particular provide properties of healing coatings.

The microgels of the invention can in particular be used in the medical field. In this field, they can in particular be used as supports for active principles, making possible, if appropriate, controlled release of the active principles. They can in particular be used as biomaterials or biocompatible materials on protheses or patches or dressings.

The microgels of the invention can in particular be used in the microstructuring or nanostructuring of surfaces.

The microgels of the invention can in particular be used as supports or carriers for various materials, for example for inorganic materials or for enzymes. They can, for example, be used to support catalysts, in particular inorganic catalysts. They can be used in the synthesis of nanometric inorganic supports. The term templates is sometimes used.

The microgels of the invention can in particular be used to trap or separate or entrain molecules. For example, they can be used to trap or separate molecules exhibiting a specific affinity with cationic units, for example anionic units. They can be used in purification processes, for example in water purification processes.

The microgels of the invention can be used as additives for modifying the rheology of liquid compositions, in particular of aqueous liquid compositions. Fluidizing or viscosifying, if they are interacted with other suitable products, may be involved.

The microgels of the invention can in particular be used in inks or in paper products, for example in compositions for coating paper.

The microgels of the invention can in particular be used in cosmetic compositions, in particular in compositions for treating the skin and/or hair, in particular in compositions intended to be rinsed off. The cosmetic compositions of interest can in particular comprise at least one surfactant, such as an anionic, amphoteric, cationic and/or nonionic surfactant. Mention is in particular made, as compositions, of leave-on creams, milks or lotions intended to be applied to the skin, sun protection compositions, hair dyeing compositions, shampoos, conditioners, shower gels or face cleaners.

The microgels of the invention can in particular be used in compositions for exploiting oil and/or gas fields. They can in particular be drilling fluids, completion fluids, stimulation fluids, fracturing fluids, production compositions or enhanced oil recovery compositions.

Other details or advantages of the invention will become apparent in the light of the examples which follow, without having a limiting nature.

### EXAMPLES

In the examples given below, the polymerization reactions are carried out under slight flushing with argon in simple glass equipment immersed in an oil bath preheated to 70° C. Use is made, as free radical generators, of 4,4′-azobis(4-cyanopentanoic acid) (ACP) or 2,2′-azobis(2-methylpropionamidine) dihydrochioride (V50). The crosslinking agent used in the following examples is N,N′-methylenebisacrylamide (MBA). The cationic monomer used below is APTAC. In all the syntheses below, use is made of a 75% by weight solution of APTAC in water. The neutral hydrophilic monomer used below is acrylamide (AM) and, for reasons of toxicity, it is handled starting from the aqueous solutions.

The conversion of the first-generation polymer is evaluated by the analysis of the (co)polymers by steric exclusion chromatography (SEC), or by gas chromatography (GC) of the residual monomers, or by high performance liquid chromatography (HPLC). The absolute weight-average molar masses Mw (g.mol⁻¹) are measured by SEC-MALS. The distribution of the molar masses is evaluated by the polydispersity index (Iₚ), corresponding to the ratio of the weight-average molar mass to the number-average molar mass (Iₚ=M_{w}/Mₙ),

These examples show that the number-average molar mass of the microgels resulting from the radical polymerization of ethylenically unsaturated monomers is determined in particular by the initial molar ratio of the monomer to the control agent. UV detection at 290 nm in SEC chromatography gives information on the presence of the control agent fragment at the end of the polymer chains, characteristic of the controlled nature of the polymerization.

### Abbreviations:

APTAC=(3-acrylamidopropyl)trimethylammonium chloride

MBA=N,N′-methylenebisacrylamide

AM=acrylamide

Xant=xanthate of EtOC(═S)SCH(CH₃)COOCH₃ type

ACP=4,4′-azobis(4-cyanopentanoic acid)

V50=2,2′-azobis(2-methylpropionamidine) dihydrochloride

### Example 1

### Preparation of an APTAC/MBA Microgel

0.190 g (9.135×10⁻⁴ mol) of the xanthate EtOC(═S)SCH(CH₃)COOCH₃, 7 g of ethanol, 7.83 g of deionized water, 4.672 g (1.70×10⁻² mol) of APTAC and 0.334 g (2.20×10⁻³ mol) of MBA are added to a two-necked round-bottomed flask surmounted by a reflux condenser. The reaction mixture is brought to 65° C. 0.023 g (8.48×10⁻⁵ mel) of V50 are added all at once at this temperature. The reaction is prolonged for 5 h.

Mn=15 700 (SEC-MALS); Mw=50 000 (SEC-MALS); Iₚ=3.2; Conversion of the monomers (HPLC)>99%.

### Example 2

### Preparation of an APTAC/AM/MBA Microgel

0.827 g (3.98×10⁻³ mol) of the xanthate EtOC(═S)SCH(CH₃)COOCH₃, 21 g of ethanol, 21 g of deionized water, 7.097 g (2.58×10⁻² mol) of APTAC, 8.55 g (6.02×10⁻² mol) of AM and 1.478 g (9.66×10⁻³′ mol) of MBA are added to a two-necked round-bottomed flask surmounted by a reflux condenser. The reaction mixture is brought to 65° C. 0.108 g (3.98×10 of V50 are added all at once at this temperature. The reaction is prolonged for 5 h. (SEC-MALS) Mn=2075, Mw=104 590, Iₚ=50.4. Conversion of the monomers (HPLC)>98%.

1-13. (canceled)

14. A chemically crosslinked polymeric microgel comprising a core C comprising:
crosslinking units R deriving from a crosslinking monomer R comprising at least two polymerizable groups, and
core C units deriving from at least one monomer C comprising just one polymerizable group, comprising:
cationic or potentially cationic units C_{cat} deriving from at least one cationic or potentially cationic monomer C_{cat}, and
optionally neutral hydrophilic or hydrophobic units C_{N} deriving from at least one neutral hydrophilic or hydrophobic monomer C_{N},
wherein the microgel is not a star copolymer comprising macromolecular branches at the periphery of the core.

15. The microgel of claim 14, wherein said microgel is capable of being obtained by a controlled radical polymerization process.

16. The microgel of claim 14, wherein the crosslinking units R comprise units deriving from a diethylenically unsaturated or triethylenically unsaturated monomer.

17. The microgel of claim 14, wherein the microgel is a polymer comprising a mixture of the following monomeric units:
at least one crosslinking monomer R comprising at least two polymerizable groups, and
at least one monomer C comprising just one polymerizable group, comprising:
at least one cationic or potentially cationic monomer C_{cat}, and
optionally a neutral hydrophilic or hydrophobic monomer C_{N}.

18. The microgel of claim 17, wherein said microgel is obtained by controlled radical polymerization.

19. The microgel of claim 17, wherein said at least two polymerizable groups comprise a polyethylenically unsaturated monomer.

20. The microgel of claim 17, wherein the molar ratio of the at least one monomer C to the crosslinking monomer R is greater than or equal to 1.

21. The microgel of claim 14, wherein said microgel comprises neutral hydrophilic units C_{Nphilic} deriving from a neutral hydrophilic monomer.

22. The microgel of claim 21, wherein the molar ratio of the units C_{cat} to the units C_{Nphilic} ranges from 1/99 to 50/50.

23. The microgel of claim 14, wherein the cationic or potentially cationic units C_{cat} comprise units deriving from monomers C_{cat} comprising:
N,N-dimethylaminomethylacrylamide or methacrylamide;
2-(N,N-dimethylamino)ethylacrylamide or methacrylamide;
3-(N,N-dimethylamino)propylacrylamide or methacrylamide;
4-(N,N-dimethylamino)butylacrylamide or methacrylamide;
2-(dimethylamino)ethyl acrylate (ADAM);
2-(dimethylamino)ethyl methacrylate (DMAM or MADAM);
3-(dimethylarnino)propyl methacrylate;
2-(tert-butylamino)ethyl methacrylate;
2-(dipentylamino)ethyl methacrylate;
2-(diethylamino)ethyl methacrylate;
vinylpyridines;
vinylamine;
vinylimidazolines;
trimethylammoniopropyl methacrylate chloride;
trimethylammonioethylacrylamide or methacrylamide chloride or bromide;
trimethylammoniobutylacrylamide or methacrylamide methyl sulfate;
trimethylammoniopropylmethacrylamide methyl sulfate (MAPTA MeS);
(3-methacrylamidopropyl)trimethylammonium chloride (MAPTAC);
(3-acrylamidopropyl)trimethylammonium chloride (APTAC);
(methacryloyloxyethyl)trimethylammonium chloride or methyl sulfate;
(acryloyloxyethyl)trimethylammonium (ADAMQUAT) salts;
1-ethyl-2-vinylpyridinium or 1-ethyl-4-vinylpyridinium bromide, chloride or methyl sulfate;
N,N-dimethyldiallylammonium chloride (DADMAC);
chloride of dimethylaminopropylmethacrylamide, N-(3-chloro-2-hydroxypropyl)trimethylammonium (DIQUAT);
the monomer of formula: 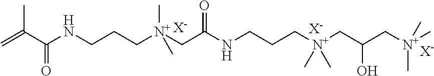
where X⁻ comprises an anion; or
mixtures thereof.

24. The microgel of claim 23, wherein X⁻ comprises chloride or methyl sulfate.

25. The microgel of claim 14, wherein the units C_{N} are neutral hydrophilic units C_{Nphilic}, deriving from monomers comprising:
hydroxyethyl acrylates and methacrylates;
acrylamide;
methacrylamide;
vinyl alcohol;
vinylpyrrolidone;
vinylcaprolactam; or
mixtures thereof.

26. The microgel of claim 14, wherein said microgel is present in an aqueous medium.

27. A process for the preparation of the microgel of claim 14, comprising controlled radical polymerization of a mixture of monomers comprising:
at least one polyethylenically unsaturated crosslinking monomer R, and
at least one monoethylenically unsaturated monomer C, comprising:
at least one cationic or potentially cationic monomer C_{cat}, and
optionally a neutral hydrophilic or hydrophobic monomer C_{N},
wherein said process does not comprise a subsequent polymerization resulting in the formation of macromolecular branches at the periphery.

28. The process of claim 27, wherein the controlled radical polymerization is carried out by bringing together the monomers, a source of free radicals, and a control agent.

29. The process of claim 28, wherein the control agent comprises a control group of formula —S—CS—.

30. The process of claim 29, wherein the control agent comprises a xanthate comprising a group of formula —S—CS—O—.

31. The process of claim 27, wherein the controlled radical polymerization is carried out in an aqueous, alcoholic, or aqueous/alcoholic medium.
